(19) United States
(12) Patent Application Publication
(10) Pub. No.: US 2026/0163485 A1
(43) Pub. Date: Jun. 11, 2026

(54) DC-DC CONVERTER CIRCUIT, AND CORRESPONDING METHOD OF OPERATION

(71) Applicant: STMicroelectronics International N.V., Geneva (CH)

(72) Inventor: Gennadii TATARCHENKOV, Munchen (DE)

(73) Assignee: STMicroelectronics International N.V., Geneva (CH)

(21) Appl. No.: 19/407,131

(22) Filed: Dec. 3, 2025

(30) Foreign Application Priority Data
Dec. 6, 2024 (IT) 102024000027726

(51) Int. Cl. H02M 3/157; H02M 1/00; H02M 3/158

(52) U.S. Cl. CPC H02M 3/157; H02M 1/0009; H02M 1/0025; H02M 3/158

(57) ABSTRACT

A DC-DC converter circuit includes: a ramp signal generator circuit; a feedback loop producing a control signal in response to an output voltage of the DC-DC converter circuit; a comparator circuit comparing the control signal to the ramp signal to produce a PWM signal; and a driver stage producing a DC-DC converter circuit power stage switch control signal in response to the PWM signal. A voltage divider produces a feedback voltage indicative of the output voltage of the DC-DC converter circuit. An error amplifier circuit produces an error voltage signal in response to a difference between the feedback voltage and a reference voltage. A filter circuit coupled to the DC-DC converter circuit output produces an AC feedback voltage signal as a function of the output voltage. A voltage adder circuit produces the control signal as a sum of the AC feedback voltage signal and the error voltage signal.

### PRIORITY CLAIM

This application claims the priority benefit of Italian Application for Patent No. 102024000027726 filed on Dec. 6, 2024, the content of which is hereby incorporated by reference in its entirety to the maximum extent allowable by law.

### TECHNICAL FIELD

The description relates to DC-DC converter circuits which can be implemented in power management integrated circuits (PMIC) for use, e.g., in battery chargers, electronic displays, cameras, systems-on-chip (SoC), wireless chargers, and the like.

### BACKGROUND

Many different types of DC-DC converters are known in the art and, similarly, many kinds of control loops for DC-DC converters are known in the art.

For instance, in DC-DC converters that operate at a fixed switching frequency, voltage mode (VM) control and current mode (CM) control are known techniques for controlling operation of the converter. On the other hand, in DC-DC converters that operate at a variable switching frequency, constant ON-time control and constant OFF-time control are known techniques for controlling operation of the converter. Each of these control schemes has its advantages and drawbacks, and may be suitable for one or more specific applications.

By construction, operation of DC-DC converters is characterized by a transfer function having a complex LC pole. There are some DC-DC converter architectures that try to cope with this complex LC pole in the control loop in different ways. However, all of them have various limitations and may not be able to achieve the expected performance (in terms of response to transients and/or AC performance) across a wide range of specification of the operating parameters. Additionally, in order to achieve better performance, the control schemes and architectures are becoming more sophisticated, which leads to a significant design complexity.

Depending on the application, several architectures can be chosen, which address some specific parameters. Among these architectures, current mode control, constant OFF-time control and constant ON-time control usually provide better performance, at the cost of design complexity.

However, current control loops have some disadvantages. For instance, since the current control loop uses an output current that is fed back into the loop upstream of the modulator, in the first approximation the control loop has no information about the converter output voltage and thus may not be able to react to the disturbances on the output voltage. Also, implementation of a current control loop may be complex. Additionally, the current control loop may be susceptible to current mode instabilities. Finally, due to sampling gain in the current control loop, the unity gain bandwidth (i.e., the frequency at which the gain of the loop is equal to 1) has to be significantly smaller than the switching frequency.

Constant OFF-time control loops and constant ON-time control loops also have some disadvantages. For instance, their design is complex due to the necessity to accurately control the switching frequency, the output voltage ripple and the coil current ripple. Additionally, these control loops may provide poor line transient performance.

U.S. Pat. No. 11,545,898 B1, incorporated herein by reference, is of interest in this field, insofar as it discloses a power converter that comprises a ramp generator circuit that includes an initial ramp generator, an offset generator, and a signal adder. The ramp signal at the output of the ramp generator circuit is provided to a first input of a modulator circuit. The power converter further comprises optional driver circuits and a power stage downstream of the modulator circuit. A first feedback loop comprises an error amplifier which compares the output voltage at the output of the power converter with a reference voltage and provides the result to the second input of the modulator circuit. A second feedback loop is coupled between the output of the power converter and the second input of the modulator circuit. The second feedback loop may comprise a high-pass filter, thus, it enables an additional AC-feedback or high-frequency feedback, and performs a pole splitting. The high-pass filter may comprise a capacitive element which is coupled between the output of the power converter and the second input of the modulator circuit via an inverting buffer, and a resistive element coupled between the capacitive element and a reference potential.

United States Patent Application Publication No. 2020/0195140 A1, incorporated by reference, may also be of interest, insofar as it illustrates a power converter that utilizes a feedback path which obtains measurement signals representative of both the inductor current and output voltage. The power converter includes a switch circuit which will include a switch coupled to an input node and having a control node. The power converter also includes a feedback path between the output node and that control node. The feedback path includes a first circuit block with a bandpass transfer function that operates on the signal drawn from the output voltage.

Other documents possibly of interest in the field of the invention include U.S. Pat. Nos. 11,552,571 B1 and 7,053,713 B1, and United States Patent Application Publication No. 2015/0061610 A1 (each of which is incorporated by reference).

However, various control loops according to the prior art may still be unsatisfactory in terms of performance, robustness and/or silicon area occupation.

Therefore, there is a need in the art to provide improved DC-DC converter circuits, and corresponding methods of operation, which include improved control loops that have better AC performance, are more robust, and/or occupy less silicon area.

### SUMMARY

One or more embodiments may relate to a DC-DC converter circuit.

One or more embodiments may relate to a corresponding method of operation.

According to an aspect of the present description, a DC-DC converter circuit comprises: a ramp generator circuit configured to produce a ramp signal; a feedback loop configured to sense an output voltage at an output terminal of the DC-DC converter circuit and produce a control signal as a function thereof; a comparator circuit configured to compare the control signal to the ramp signal to produce a pulse-width modulated (PWM) signal; and a driver stage configured to receive the PWM signal and produce at least one switch control signal for at least one electronic switch of a power stage of the DC-DC converter circuit. The power stage is configured to produce a switching signal at a switching node of the DC-DC converter circuit. The switching node is configured for coupling to an inductor. The feedback loop includes: a voltage divider coupled to the output terminal of the DC-DC converter circuit and configured to produce a feedback voltage indicative of the output voltage; an error amplifier circuit configured to produce an error voltage signal as a function of a difference between the feedback voltage and a reference voltage; a high-pass or band-pass filter circuit coupled to the output terminal of the DC-DC converter circuit and configured to produce an AC feedback voltage signal as a function of the output voltage; and a voltage adder circuit having a first input configured to receive the AC feedback voltage signal, a second input configured to receive the error voltage signal, and an output configured to produce the control signal as the sum of the AC feedback voltage signal and the error voltage signal.

One or more embodiments may thus provide a DC-DC converter circuit with improved transient performance thanks to the splitting of the LC pole, which has a small area and high robustness.

According to another aspect of the present description, a method of operating a DC-DC converter circuit according to one or more embodiments includes: producing a ramp signal by a ramp generator circuit; sensing an output voltage at an output terminal of the DC-DC converter circuit and producing a control signal as a function thereof by the feedback loop; comparing the control signal to the ramp signal to produce a pulse-width modulated, PWM, signal by a comparator circuit; receiving the PWM signal at a driver stage and producing at least one switch control signal for at least one electronic switch of a power stage of the DC-DC converter circuit; producing a switching signal at a switching node of the DC-DC converter circuit by the power stage; producing a feedback voltage indicative of the output voltage by a voltage divider; producing an error voltage signal as a function of a difference between the feedback voltage and a reference voltage by an error amplifier circuit; producing an AC feedback voltage signal as a function of the output voltage by a high-pass or band-pass filter circuit; and receiving the AC feedback voltage signal and the error voltage signal at a voltage adder circuit, and producing the control signal as the sum of the AC feedback voltage signal and the error voltage signal by the voltage adder circuit.

### BRIEF DESCRIPTION OF THE DRAWINGS

One or more embodiments will now be described, by way of example only, with reference to the annexed figures, wherein:

FIG. 1 is a circuit block diagram exemplary of a DC-DC converter circuit;

FIG. 2 is a circuit diagram exemplary of a possible detailed implementation of an adder circuit of the control loop of the DC-DC converter of FIG. 1;

FIG. 3 is a block diagram exemplary of signal processing in the DC-DC converter of FIG. 1;

FIG. 4 is a diagram exemplary of the amplitude of the transfer function of the DC-DC converter of FIG. 1 in one case;

FIG. 5 is a diagram exemplary of the amplitude of the transfer function of the DC-DC converter of FIG. 1 in other cases; and

FIG. 6 is a circuit block diagram exemplary of another DC-DC converter circuit.

### DETAILED DESCRIPTION

In the ensuing description, one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is included in at least one embodiment. Hence, phrases such as “in an embodiment” or “in one embodiment” that may be present in one or more points of the present description do not necessarily refer to one and the same embodiment. Moreover, particular configurations, structures, or characteristics may be combined in any adequate way in one or more embodiments.

The headings/references used herein are provided merely for convenience and hence do not define the extent of protection or the scope of the embodiments.

Throughout the figures annexed herein, unless the context indicates otherwise, like parts or elements are indicated with like references/numerals and a corresponding description will not be repeated for the sake of brevity.

As anticipated, the present description relates to a DC-DC converter circuit including a control loop that aims at mitigating one or more of the drawbacks of the conventional DC-DC converter circuits, in particular in order to provide better AC (transient) performance, higher robustness and/or a smaller silicon footprint. In particular, one or more embodiments may rely on a conventional voltage mode (VM) control architecture, supplemented with an AC control loop.

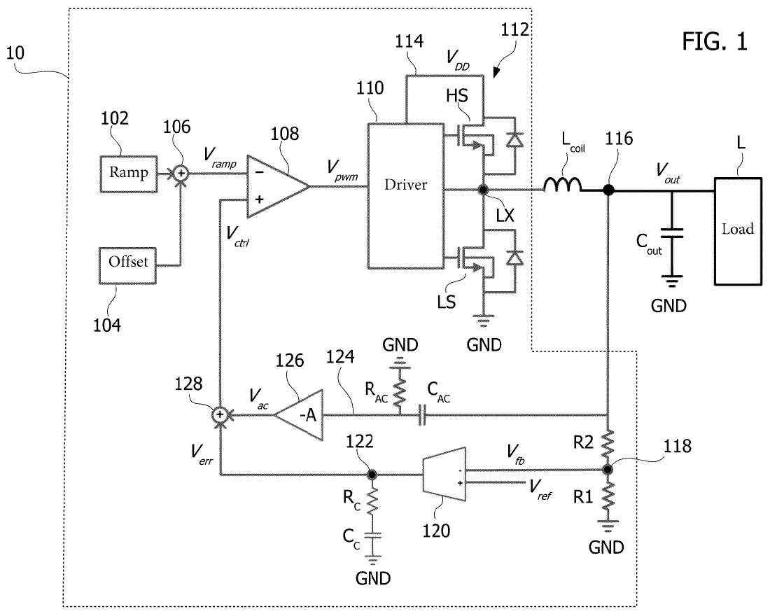

FIG. 1 is a circuit block diagram exemplary of such a DC-DC converter circuit 10 (e.g., implemented in an integrated circuit, IC) coupled to an external inductor L_{coil}, an external capacitor Cₒᵤₜ and a load L. In particular, the DC-DC converter 10 includes a baseline ramp generator circuit 102 configured to generate a baseline ramp voltage signal and an offset generator circuit 104 configured to generate an offset voltage signal (also referred to as pedestal generator and pedestal voltage in the present description). The converter 10 includes an adder circuit 106 configured to add the baseline ramp voltage signal from circuit 102 and the offset voltage signal from circuit 104 to produce a (shifted) ramp signal Vᵣₐₘₚ. The circuits 102, 104 and 106 may be globally referred to as a ramp generator. The converter 10 includes a comparator circuit 108 having a first input (e.g., negative) configured to receive the ramp signal Vᵣₐₘₚ and a second input (e.g., positive) configured to receive a control signal V_{ctrl} produced by a feedback and control loop of the converter 10, as further described in the following. By comparing signals Vᵣₐₘₚ and V_{ctrl}, the comparator 108 produces a pulse-width modulated (PWM) signal V_{pwm} for driving the power stage of the DC-DC converter 10. In this regard, the DC-DC converter 10 exemplified herein includes a buck power stage (i.e., a step-down conversion stage), but it will be appreciated that a control loop according to one or more embodiments of the present description may be implemented in any type of DC-DC converter (e.g., buck, boost, buck-boost, and the like). The converter 10 includes a driver stage 110 configured to receive the PWM signal V_{pwm} and produce the switch control signals for a high-side switch HS and a low-side switch LS of a half-bridge power stage 112. The power stage 112 may include a high-side switch HS having a selectively-activatable current path arranged between a supply voltage rail 114 that provides a supply voltage V_{DD} and a switching node LX, and a low-side switch LS having a selectively-activatable current path arranged between the switching node LX and ground GND. For instance, the high-side switch HS may include an n-channel metal-oxide-semiconductor (MOS) transistor having a drain terminal coupled to the supply voltage rail 114, a source terminal coupled to the switching node LX, and a gate terminal controlled by the driver stage 110. For instance, the low-side switch LS may include an n-channel MOS transistor having a drain terminal coupled to the switching node LX, a source terminal coupled to ground GND, and a gate terminal controlled by the driver stage 110. In FIG. 1, body diodes of the transistors HS, LS of the power stage 112 are also illustrated. The driver stage 110 may include, in a manner known per se, various circuits configured to control the half-bridge stage 112 based on the PWM signal V_{pwm} such as, for instance, a non-overlapping circuit (i.e., a circuit that makes sure that the low-side transistor and the high-side transistor are not turned on simultaneously), one or more level shifters, a bootstrap circuit, one or more gate drivers, and the like.

As exemplified in FIG. 1, the switching node LX may be coupled to an output pin of the integrated circuit of the DC-DC converter 10, so that an external inductor (coil) L_{coil} can be coupled between the switching node LX and an output terminal 116 where the output voltage Vₒᵤₜ (e.g., regulated voltage) is produced. Additionally, an (external) output capacitor Cₒᵤₜ may be coupled between the output terminal 116 and ground GND, and a load L may also be coupled between the output terminal 116 and ground GND to be supplied by the (regulated) output voltage Vₒᵤₜ.

As anticipated, the DC-DC converter 10 may additionally include a voltage-mode (VM) control loop. The control loop may include a voltage divider coupled between a pin of the integrated circuit that is configured for coupling to the output terminal 116 and ground GND, to receive the output voltage Vₒᵤₜ and produce a feedback voltage V_{fb} indicative of the output voltage (e.g., proportional to the output voltage). For instance, the voltage divider may include a first resistor R1 coupled between ground GND and a feedback node 118, and a second resistor R2 coupled between the feedback node 118 and the output terminal 116, so that the feedback voltage V_{fb} is produced at the intermediate node 118. The control loop may include an error amplifier 120 (e.g., a transconductance amplifier) having a first input (e.g., inverting input) configured to receive the feedback voltage V_{fb}, a second input (e.g., non-inverting input) configured to receive a reference voltage V_{ref}, and an output configured to produce an error voltage signal Vₑᵣᵣ at a node 122, based on the difference between signals V_{ref} and V_{fb}. The control loop may include a compensation network coupled to the output of the error amplifier 120, which may include, for instance, a compensation resistor R_{C} and a compensation capacitor C_{C} coupled in series between node 122 and ground GND.

In some conventional architectures, the error signal Vₑᵣᵣ is directly passed to the second input of the comparator 108 as the control signal V_{ctrl}. However, these architectures may be affected by the issues discussed above in the background section. Therefore, one or more embodiments according to the present description include an additional feedback loop arranged between the output terminal 116 and the second input (e.g., positive input) of the comparator circuit 108, to determine the control signal V_{ctrl}. In particular, as exemplified in FIG. 1, the additional feedback loop may include a high-pass or band-pass filter circuit configured to receive the output voltage Vₒᵤₜ from the output terminal 116, optionally followed by a gain stage, and configured to produce an AC feedback signal V_{ac}. For instance, the filter circuit may include a capacitor C_{AC} coupled between the output terminal 116 and a node 124, and a resistor R_{AC} coupled between node 124 and ground GND. The optional gain stage may include an inverting stage 126 (e.g., having a negative gain indicated herein as −A) having an input coupled to node 124 to receive the AC signal from the filter circuit C_{AC}, R_{AC} and an output configured to produce the AC feedback signal V_{ac}. Further, the control loop of the converter 10 includes an adder circuit 128 configured to add the error signal Vₑᵣᵣ from circuit 120 and the AC feedback signal V_{ac} from circuit 126 to produce the control signal V_{ctrl} that is passed to the second input (e.g., positive input) of the comparator circuit 108.

The feedback implemented by the AC-coupled loop provides a fast path from the output terminal 116 (where the output voltage Vₒᵤₜ is produced) to the second (e.g., positive) terminal of comparator 108. With the additional AC-coupled loop, the feedback path closes the loop with the modulator stage (i.e., with the comparator 108) and allows the pole splitting of the complex LC pole, improving the response to transients and the AC performance of the DC-DC converter.

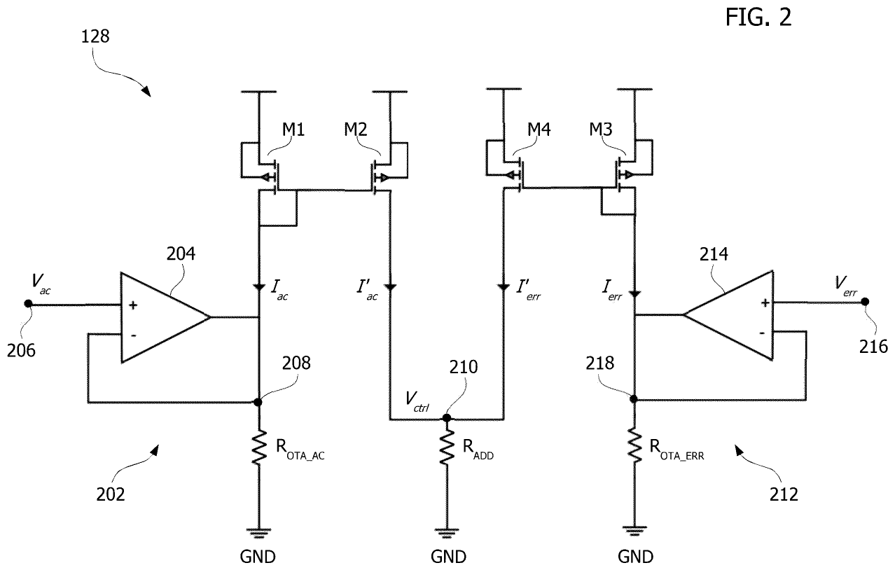

Advantageously, in one or more embodiments the AC-coupled (fast) loop and the DC-coupled (slow) loop do not interact with each other (that is, they do not see the output impedances of each other). This is obtained by adding the voltage signals Vₑᵣᵣ and V_{ac} at the adder 128, so that the transfer functions of the two loops do not influence each other and the control signal V_{ctrl} results from simple voltage summation of signals Vₑᵣᵣ and V_{ac}: V_{ctrl}=Vₑᵣᵣ+V_{ac}. In this regard, a possible detailed implementation of the adder circuit 128 is depicted in the circuit diagram of FIG. 2.

The adder 128 may include a first voltage-to-current (V2I) converter circuit 202 configured to receive the AC feedback signal V_{ac} and produce a current indicative of (e.g., proportional to) the signal V_{ac}. For instance, the V2I converter 202 may include an amplifier circuit 204 (e.g., an operational transconductance amplifier (OTA)) having a first (e.g., non-inverting) input coupled to an input node 206 for receiving signal V_{ac} (e.g., from the gain stage 126 or from node 124 of the filter circuit) and a second (e.g., inverting) input directly connected to its output node 208, and a resistor R_{OTA_AC} coupled between node 208 and ground GND. With this arrangement, voltage V_{ac} is passed to node 208 (insofar as the amplifier 204 operates as a voltage follower) and a current I_{ac}=V_{ac}/R_{OTA_AC} is sunk by resistor R_{OTA_AC} at node 208. The adder 128 may include a first current mirror circuit (e.g., a pMOS current mirror) configured to copy the current I_{ac} (e.g., via a diode-connected p-channel MOS transistor M1 having its conductive channel connected in series to resistor R_{OTA_AC}) and source a copied current I′_{ac} (possibly equal to I_{ac}) to a node 210 (e.g., via a p-channel MOS transistor M2 having its conductive channel connected in series between a supply node and node 210, and its gate terminal connected to the gate terminal of transistor M1).

The adder 128 may further include a second V2I converter circuit 212 configured to receive the error signal Vₑᵣᵣ and produce a current indicative of (e.g., proportional to) the signal Vₑᵣᵣ. For instance, the V2I converter 212 may include an amplifier circuit 214 (e.g., an operational transconductance amplifier, OTA) having a first (e.g., non-inverting) input coupled to an input node 216 for receiving signal Vₑᵣᵣ (e.g., from node 122 at the output of the amplifier 120) and a second (e.g., inverting) input directly connected to its output node 218, and a resistor R_{OTA_ERR} coupled between node 218 and ground GND. With this arrangement, voltage Vₑᵣᵣ is passed to node 218 (insofar as the amplifier 214 operates as a voltage follower) and a current Iₑᵣᵣ=Vₑᵣᵣ/R_{OTA_ERR} is sunk by resistor R_{OTA_ERR} at node 218. The adder 128 may include a second current mirror circuit (e.g., a pMOS current mirror) configured to copy the current Iₑᵣᵣ (e.g., via a diode-connected p-channel MOS transistor M3 having its conductive channel connected in series to resistor R_{OTA_ERR}) and source a copied current I′ₑᵣᵣ (possibly equal to Iₑᵣᵣ) to node 210 (e.g., via a p-channel MOS transistor M4 having its conductive channel connected in series between a supply node and node 210, and its gate terminal connected to the gate terminal of transistor M3).

A further resistor R_{ADD} is connected between node 210 and ground GND, so that a total current I′_{ac}+I′ₑᵣᵣ flows through resistor R_{ADD} and the control voltage V_{ctrl} is produced at node 210: V_{ctrl}=R_{ADD}*(T′_{ac}+I′ₑᵣᵣ)=R_{ADD}*(I_{ac}+Iₑᵣᵣ).

The adder architecture exemplified in FIG. 2 allows for the AC-coupled loop (that produces voltage V_{ac}) and the DC-coupled loop (that produces voltage Vₑᵣᵣ) not to see each other's impedance (insofar as impedances are decoupled via the amplifiers 204 and 214). Moreover, the gain of each loop can be adjusted by configuring (e.g., sizing) the transistors M1, M2, M3, M4 and resistors R_{OTA_AC}, R_{ADD} and R_{OTA_ERR}, thereby possibly implementing the gain stage 126 within the adder circuit itself. Additionally, no extra signals are required to carry out the summation.

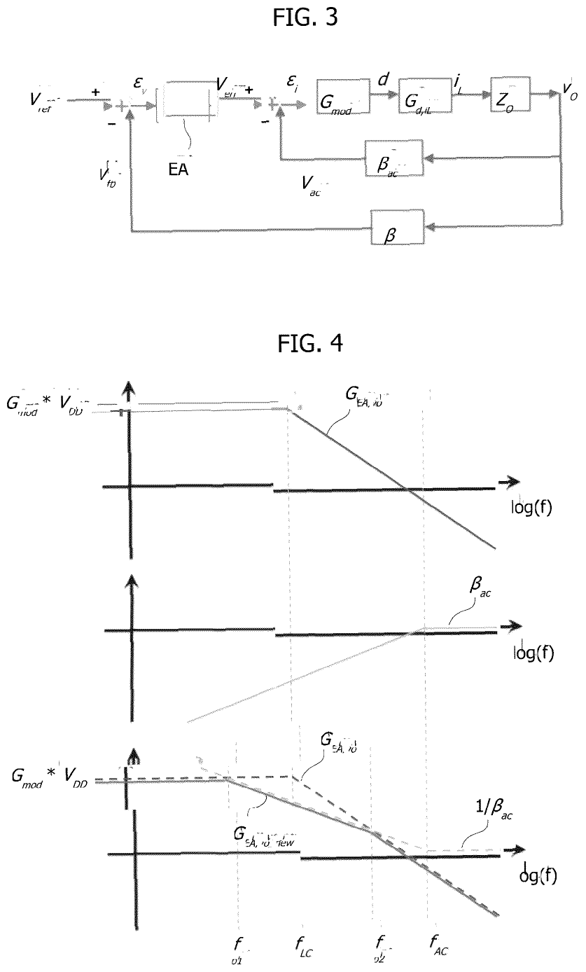

Operation of the DC-DC converter 10 as exemplified in FIGS. 1 and 2 may be further described with reference to FIGS. 3 and 4. In particular, FIG. 3 is a block diagram exemplary of small signal processing in the DC-DC converter 10, and FIG. 4 is a diagram exemplary of the amplitude of the transfer function of the DC-DC converter 10.

As exemplified in FIG. 3, in order to control the DC-DC converter 10, a difference is determined between the reference signal V_{ref} and the feedback signal V_{fb} to produce a difference signal ε_{V}. The difference signal Ev passes through the error amplifier 120 (whose operation is indicated by block EA in FIG. 3) to produce the error signal Vₑᵣᵣ. The AC feedback signal V_{ac} is subtracted from the error signal Vₑᵣᵣ to produce another difference signal εᵢ (note that FIG. 3 shows a subtraction between signals Vₑᵣᵣ and V_{ac} in order to account for the negative gain of the gain stage 126, illustrated in FIG. 1). Signal εᵢ is subject to a first gain G_{mod} to produce signal d, which is subject to a second gain G_{d,iL} to produce the coil current i_{L}, which is then multiplied by the output impedance Z_{O} to produce the output voltage vₒ. The gain of the DC feedback loop is indicated by β (e.g., to account for the resistor ratio R2/(R1+R2)), and the gain of the AC feedback loop is indicated by β_{AC}. The values of G_{mod}, G_{d,iL}, Z_{O}, and β_{AC} can be expressed by the following equations:

$${G}_{mod} = \frac{{F}_{SW}}{{S}_{CR , V}}$$

$${G}_{d , iL} = \frac{{V}_{DD}}{{Z}_{L} + {Z}_{C}}$$

$${Z}_{0} = {Z}_{C}$$

$${β}_{AC} = A * \frac{s \cdot {C}_{A C} \cdot {R}_{A C}}{1 + s \cdot {C}_{A C} \cdot {R}_{A C}}$$

FIG. 4 includes three diagrams. The first (topmost) diagram shows the magnitude G_{EA, vo} of the transfer function of the converter 10 according to the conventional voltage-mode control loop, which is stable at value G_{mod}*V_{DD} up to the frequency f_{LC} of the complex pole, and then decreases at a rate of −40 dB/dec. The second (middle) diagram shows the magnitude β_{AC} of the gain of the AC feedback loop alone, which has a zero in the origin and a pole at frequency f_{AC}, after which it remains stable at value A. The third (lowermost) diagram shows in dashed lines the amplitudes G_{EA, vo} and 1/β_{AC}, and in solid line the resulting magnitude G_{EA, vo_new} of the transfer function of the converter 10 according to the diagram of FIG. 1 (i.e., including a conventional voltage-mode control loop and the additional AC-coupled feedback loop), which is stable at value G_{mod}*V_{DD} up to the frequency fₚ₁ of a first pole, then decreases at a rate of −20 dB/dec up to the frequency fₚ₂ of a second pole, and then decreases at a rate of −40 dB/dec. The frequency f_{AC} can be expressed by the following equation:

$${f}_{A C} = \frac{1}{2 π {C}_{A C} \cdot {R}_{A C}}$$

Therefore, by applying a feedback via the AC-coupled loop, the complex LC pole at frequency f_{LC} is split into two separate poles at frequencies fₚ₁ and fₚ₂ that are defined by the configuration of the high-pass or band-pass filter (C_{AC} and R_{AC}). The frequencies fₚ₁ and fₚ₂ can be expressed by the following equations:

$${f}_{p 1} = \frac{1}{2 π {C}_{A C} \cdot {R}_{A C} \cdot {G}_{m o d} \cdot {V}_{D D}}$$

$${f}_{p 2} = \frac{{C}_{A C} \cdot {R}_{A C} \cdot {G}_{m o d} \cdot {V}_{D D}}{2 π L \cdot C}$$

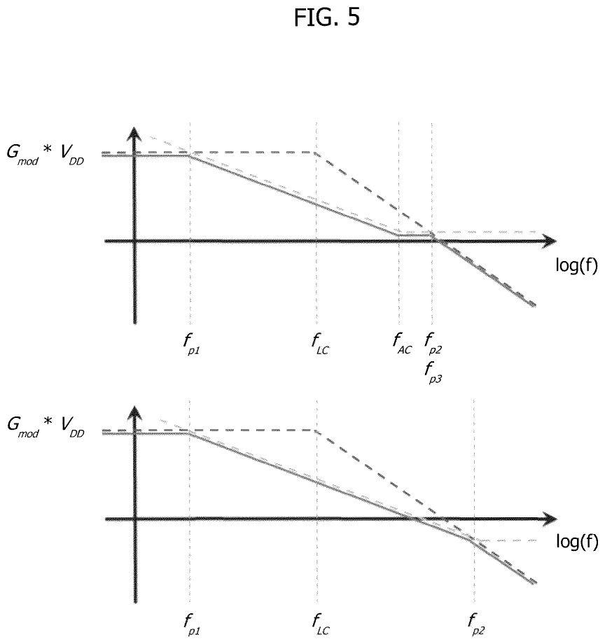

FIG. 5 includes two diagrams exemplary of the amplitude of the transfer function of the DC-DC converter of FIG. 1 in other cases. The upper diagram of FIG. 5 shows in dashed lines the amplitudes G_{EA, vo} and 1/β_{AC}, and in solid line the resulting magnitude G_{EA, vo_new} of the transfer function of the converter 10 according to the diagram of FIG. 1, having one pole at frequency fₚ₁, one zero at frequency f_{AC}, and two complex poles at frequencies fₚ₂ and fₚ₃. The frequencies fₚ₁, f_{AC}, fₚ₂ and fₚ₃ can be expressed by the following equations:

$${f}_{p 1} = \frac{1}{2 π {C}_{A C} \cdot {R}_{A C} \cdot {G}_{m o d} \cdot {V}_{D D}}$$

$${f}_{A C} = \frac{1}{2 π {C}_{A C} \cdot {R}_{A C}}$$

$${f}_{p 2} , {f}_{p 3} = \frac{\sqrt{{G}_{m o d} \cdot {V}_{D D}}}{2 π L \cdot C}$$

The lower diagram of FIG. 5 shows in dashed lines the amplitudes G_{EA, vo} and 1/β_{AC}, and in solid line the resulting magnitude G_{EA, vo_new} of the transfer function of the converter 10 according to the diagram of FIG. 1, having one pole at frequency fₚ₁ and another pole at frequency fₚ₂ equal to f_{AC}. The frequencies fₚ₁, f_{AC} and fₚ₂ can be expressed by the following

$${f}_{p 1} = \frac{1}{2 π {C}_{A C} \cdot {R}_{A C} \cdot A \cdot {G}_{m o d} \cdot {V}_{D D}}$$

$${f}_{A C} = {f}_{p 2} = \frac{1}{2 π {C}_{A C} \cdot {R}_{A C}}$$

Therefore, in one or more embodiments the implementation of a voltage-mode (VM) control loop supplemented by an AC-coupled feedback loop allows to split the complex LC pole of the transfer function of the DC-DC converter. By increasing the product C_{AC}*R_{AC}, it is possible to split the complex LC poles further apart, while improving transient performance. Additionally, thanks to the implementation of the AC-coupled loop, the loop design becomes easier insofar as there are no effects of external components within unity gain bandwidth (UGB). Furthermore, the use of VM+AC control loop has better transient performance and power supply rejection ratio (PSRR) than the conventional solutions, as well as better performance for various functional transitions (e.g., DVC, phase shedding).

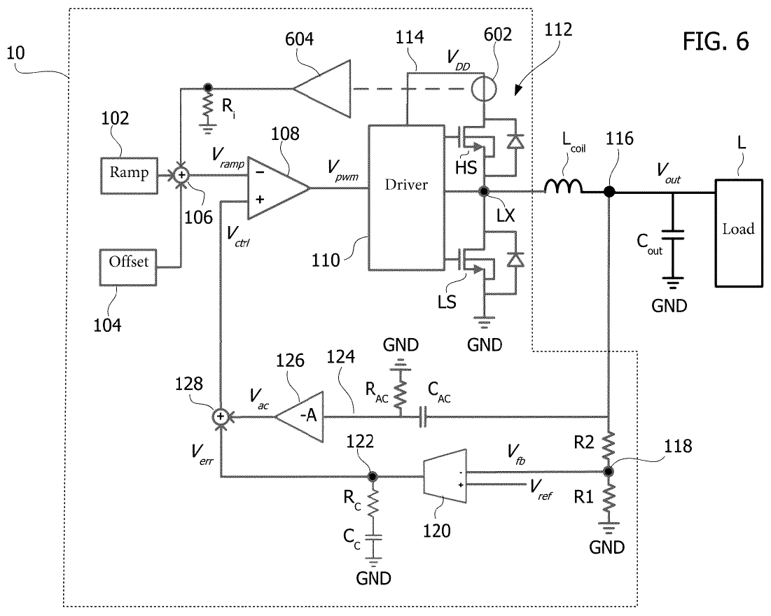

It is noted that the AC-coupled loop can be integrated into already existing designs that have other control schemes (e.g., current mode, constant OFF-time, constant ON-time) and improve the pole splitting or transient performance. For instance, FIG. 6 is a circuit block diagram exemplary of a DC-DC converter circuit 10 having a current mode (CM) control loop, which incorporates the AC-coupled loop (i.e., components C_{AC}, R_{AC}, 126, 128). The CM control loop, as exemplified, may include a current sensing arrangement 602 configured to sense the current that flows through the half-bridge stage 112 (in particular, through the high-side switch HS), and a current sense amplifier 604 coupled to the circuit 602 and configured to produce an output (current) signal based on the sensed current, in a manner known per se. The output signal of the current sense amplifier 604 is passed to a resistor Ri coupled to ground so as to produce a further voltage signal that is passed to the adder circuit 106.

Without prejudice to the underlying principles, the details and embodiments may vary, even significantly, with respect to what has been described by way of example only, without departing from the extent of protection.

The claims are an integral part of the technical teaching provided herein in respect of the embodiments.

The extent of protection is determined by the annexed claims.

1. A DC-DC converter circuit, comprising:
a ramp generator circuit configured to produce a ramp signal;
a feedback loop configured to sense an output voltage at an output terminal of the DC-DC converter circuit and produce a control signal as a function thereof;
a comparator circuit configured to compare the control signal to the ramp signal to produce a pulse-width modulated (PWM) signal; and
a driver stage configured to receive the PWM signal and produce at least one switch control signal for at least one electronic switch of a power stage of the DC-DC converter circuit, the power stage being configured to produce a switching signal at a switching node of the DC-DC converter circuit, the switching node being configured for coupling to an inductor;
wherein the feedback loop comprises:
a voltage divider coupled to the output terminal of the DC-DC converter circuit and configured to produce a feedback voltage indicative of the output voltage;
an error amplifier circuit configured to produce an error voltage signal as a function of a difference between the feedback voltage and a reference voltage;
a high-pass or band-pass filter circuit coupled to the output terminal of the DC-DC converter circuit and configured to produce an AC feedback voltage signal as a function of the output voltage; and
a voltage adder circuit having a first input configured to receive the AC feedback voltage signal, a second input configured to receive the error voltage signal, and an output configured to produce the control signal as a sum of the AC feedback voltage signal and the error voltage signal.

2. The DC-DC converter circuit of claim 1, wherein the high-pass or band-pass filter circuit comprises a filter capacitor coupled between the output terminal of the DC-DC converter circuit and a filter output node, and a filter resistor coupled between the filter output node and ground.

3. The DC-DC converter circuit of claim 1, wherein the feedback loop comprises a gain stage coupled between an output node of the high-pass or band-pass filter circuit and the first input of the voltage adder circuit.

4. The DC-DC converter circuit of claim 3, wherein gain stage is an inverting gain stage.

5. The DC-DC converter circuit of claim 1, wherein the voltage adder circuit comprises:
a first voltage-to-current (V2I) converter circuit configured to receive the AC feedback voltage signal and produce a first current indicative thereof;
a second V2I converter circuit configured to receive the error voltage signal and produce a second current indicative thereof;
a current summation node configured to sum the first and second currents; and
a resistor coupled to the current summation node and ground;
wherein the control signal is produced at the current summation node.

6. The DC-DC converter circuit of claim 5, wherein the first current is mirrored before application to the current summation node and the second current is mirrored before application to the current summation node.

7. The DC-DC converter circuit of claim 5, wherein said first V2I converter circuit and said second V2I converter circuit each comprise a respective amplifier circuit having a respective first input configured to receive the respective input signal and a respective second input directly connected to the respective output node of the V2I converter circuit, and a respective resistor coupled between the respective output node and ground.

8. The DC-DC converter circuit of claim 1, wherein the feedback loop comprises a compensation network coupled between an output terminal of the error amplifier circuit and ground.

9. The DC-DC converter circuit of claim 8, wherein the compensation network comprises a compensation resistor and a compensation capacitor coupled in series between the output terminal of the error amplifier circuit and ground.

10. A method of operating a DC-DC converter circuit, comprising:
producing a ramp signal using a ramp generator circuit;
sensing an output voltage at an output terminal of the DC-DC converter circuit and producing a control signal as a function thereof using a feedback loop;
comparing the control signal to the ramp signal to produce a pulse-width modulated, PWM;
receiving the PWM signal at a driver stage and producing at least one switch control signal for at least one electronic switch of a power stage of the DC-DC converter circuit;
producing a switching signal at a switching node of the DC-DC converter circuit using the power stage;
producing a feedback voltage indicative of the output voltage using a voltage divider;
producing an error voltage signal as a function of a difference between the feedback voltage and a reference voltage using an error amplifier circuit;
producing an AC feedback voltage signal as a function of the output voltage using a high-pass or band-pass filter circuit; and
producing the control signal by summing the AC feedback voltage signal and the error voltage signal.
